(19) United States
(12) Patent Application Publication
(10) Pub. No.: US 2009/0162590 A1
(43) Pub. Date: Jun. 25, 2009

(54) Polypropylene Composition for Injection Stretch Blow Molding

(75) Inventors: Jerome Thierry-Mieg, Houston, TX (US); Dang Le, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/393,725

(22) Filed: Feb. 26, 2009

Related U.S. Application Data
(62) Division of application No. 11/148,484, filed on Jun. 9, 2005.

(51) Int. Cl. B29C 49/08; B32B 1/08

(52) U.S. Cl. 428/36.9; 264/532

(57) ABSTRACT

A method of manufacturing an end-use article comprising: preparing a polymeric composition and converting the polymeric composition into an end-use article by injection stretch blow molding, wherein the article has an initial flexural modulus from about 100,000 psi to about 150,000 psi. A method of manufacturing an end-use article comprising: preparing a polymeric composition; converting the polymeric composition into an end-use article by injection stretch blow molding; and determining the initial mechanical properties of the end-use article. Articles prepared by the disclosed methodologies.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to polymeric compositions and end-use articles made from same. More specifically, this invention relates to polypropylene compositions and end-use articles that rapidly develop high impact strength following a plastics shaping process.

2. Background of the Invention

Synthetic polymeric materials, particularly plastic resins, are manufactured into a variety of end-use articles ranging from medical devices to food containers. Current manufacturing methods often begin with the production of a preform or intermediate article from resin pellets. This preform is designed so as to allow its facile conversion to any number of end-use articles through a plastics shaping process, such as injection stretch blow molding. The shaping processes employ heat and/or pressure to convert the polymeric material into the desired end-use article.

Following formation, the end-use article may be fed onto shipping pallets which when filled to capacity may hold several hundred articles. Typically, the filled pallets are stacked vertically to some predetermined height before they are removed for shipping. Ideally, in a high throughput manufacturing process, a molded article may be formed, filled with a consumer product, packed onto a pallet and subsequently stacked for shipping in a matter of minutes. Consequently, within minutes of being formed, a molded article may experience a significant compressive force from being palletized and packed that could result in deformation of the article. In practice, the packing and palletizing of molded articles may be adjusted to compensate for the compressive forces that result in article deformation. However, these adjustments may negatively affect the manufacturing efficiency. Thus, it would be desirable to develop a method of manufacturing a polymeric article capable of rapidly acquiring mechanical strength sufficient to prevent deformation when packed and palletized.

### BRIEF SUMMARY OF SOME OF THE PREFERRED EMBODIMENTS

In an embodiment, a method of manufacturing an end-use article is disclosed comprising preparing a polymeric composition and converting the polymeric composition into an end-use article by injection stretch blow molding wherein the article has an initial flexural modulus from about 100,000 psi to about 160,000 psi. In another embodiment an article prepared by this method is disclosed.

In an embodiment, a method of manufacturing an end-use article is disclosed comprising preparing a polymeric composition, converting the polymeric composition into an end-use article by injection stretch blow molding, and determining the initial mechanical properties of the end-use article.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a graphical representation of the flexural modulus as a function of time.

### DETAILED DESCRIPTION OF THE PREFERRED EMBODIMENTS

End-use articles are prepared from a polymeric composition comprising a polymer of propylene (PP) and a modifier. In an embodiment, the modifier may be a nucleator, a clarifier or combinations thereof. The PP may be a copolymer, for example a copolymer of propylene with one or more alpha olefin monomers such as ethylene, butene, hexene, etc. In an embodiment, the PP is a random ethylene-propylene (C₂/C₃) copolymer (rcPP) and may comprise from about 0.1 wt. % to about 5 wt. % ethylene, alternatively from about 0.5 wt. % to about 4 wt. % ethylene, alternatively from about 1 wt. % to about 3 wt. % ethylene.

In an embodiment, the rcPP has a melt flow rate (MFR) of from about 2 g/10 min. to about 80 g/10 min., alternatively from about 5 g/10 min. to about 35 g/10 min., alternatively from about 7 g/10 min. to about 25 g/10 min. MFR as defined herein refers to the quantity of a melted polymer resin that will flow through an orifice at a specified temperature and under a specified load. Without wishing to be limited by theory, polymeric compositions of this disclosure having the indicated MFR will allow for easy molding of the end-use article with a resultant acceptable wall thickness distribution. The MFR may be determined using a dead-weight piston Plastometer that extrudes polypropylene through an orifice of specified dimensions at a temperature of 230° C., and a load of 2.16 kg in accordance with ASTM D-1238. The rcPP may have a melting point range of from about 120° C. to about 165° C.; alternatively from about 150° C. to about 155° C. The melting point range is indicative of the degree of crystallinity of the polymer.

Without limitation, an example of a suitable rcPP is 6823 MZ, an ethylene-propylene random copolymer available from Total Petrochemicals USA, Inc. In an embodiment, the rcPP (e.g., 6823 MZ) has about the physical properties set forth in Table I.

TABLE I

| Resin Properties⁽¹⁾ | Typical Value | | ASTM Method |
|---|---|---|---|
| Melt Flow, g/10 min. | 32 | | D-1238 |
| | | | Condition “L” |
| Density, g/cc | 0.900 | | D-1505 |
| Melting Point, ° F. (° C.) | 300 | (149) | DSC⁽²⁾ |

Mechanical Properties⁽¹⁾

| Tensile, psi (MPa) | 4,500 | (31.0) | D-638 |
|---|---|---|---|
| Elongation, % | 10 | | D-638 |
| Tensile modulus, psi (MPa) | 180,000 | (1,240) | D-638 |
| Flexural Modulus, psi (MPa) | 150,000 | (1,035) | D-790 |
| Notched Izod Impact @ | 1 | (53.4) | D-256A |
| 73° F.-ft.lb./in. (J/m) | | | |
| Unnotched-ft.lb/in (J/m) | No Breaks | (No Breaks) | |
| Drop Impact, 0.125″ plaques, | 140 | (15.8) | API |
| in.-lbs (J) | | | |

| | | |
|---|---|---|
| Hardness Rockwell R | 90 | |
| | | D-785A |

Thermal Properties⁽¹⁾

| | | |
|---|---|---|
| Heat Deflection | | D-648 |
| ° F. at 66 psi | 185 | |
| ° C. at 4.64 kg/cm² | 85 | |

⁽¹⁾Data developed under laboratory conditions and are not to be used as specification, maxima or minima.
⁽²⁾MP determined with a DSC-2 Differential Scanning Calorimeter.

rcPPs are formed by the catalyzed polymerization of a mixture of C₂ and C₃ monomers. rcPPs may be prepared through the use of conventional Ziegler-Natta catalysts of the type disclosed, for example in U.S. Pat. Nos. 4,298,718 and 4,544,717, both to Myer et al, each of which is incorporated herein by reference. rcPPs may also be prepared through the use of metallocene catalysts of the type disclosed and described in further detail in U.S. Pat. Nos. 5,158,920, 5,416,228, 5,789,502, 5,807,800, 5,968,864, 6,225,251, and 6,432,860, each of which is incorporated herein by reference. Standard equipment and procedures for polymerizing the propylene and ethylene into a random copolymer are known to one skilled in the art.

The polymeric composition may comprise a modifier such as a nucleator or clarifier. These modifiers may enhance resin performance properties such as stiffness and heat resistance. A nucleator or a clarifier may also be added to enhance the aesthetic appeal of a formed product by making it more transparent.

Herein nucleators refer to compounds that increase the rate of crystallization of the polymer. Herein clarifiers refer to a subset of nucleators that increase both the rate of crystallization and the optical properties of the polymeric materials. During crystallization of a polymer such as rcPP, the crystals formed are typically larger than the wavelength of light. Crystals of this size refract light and thus can reduce the clarity of the copolymer. Without wishing to be limited by theory, a nucleator may provide a heterogeneous surface that acts as a crystallization site and increases the rate of polymer crystallization. In the presence of a nucleator, crystals may form at higher temperatures and the higher rate of crystal formation induces formation of smaller crystals such as spherulites. The smaller crystal size allows light to pass with reduced refraction, thereby increasing the clarity of the polymer. Both clarifiers and nucleators increase the rate of crystallization of the polymeric material resulting in improved mechanical properties such as hardness and impact resistance. However, while all clarifiers nucleate not all nucleators clarify although typically addition of a nucleator will result in some improvement in optical properties.

In an embodiment, any nucleator or clarifier chemically compatible with the polymeric composition, e.g., a C₂/C₃ random copolymer and that is able to improve the mechanical and optical properties thereof may be included in the composition. Such nucleators or clarifiers may be added in amounts effective to impart the desired properties.

In an embodiment, the nucleator is an aromatic carboxylic acid salt, alternatively a metal benzoate, alternatively sodium benzoate present in amounts ranging iteratively from about 500 ppm to about 2000 ppm, alternatively from about 500 ppm to about 1500 ppm, alternatively from about 500 ppm to about 1000 ppm. Alternatively, the nucleator may be talc present in amounts ranging iteratively of from about 1500 ppm to about 5000 ppm, alternatively from about 1500 ppm to about 3500 ppm, alternatively from about 1500 ppm to about 2000 ppm.

The nucleator and clarifier may function as a single entity. In an embodiment, the nucleator may be an organophosphate present in amounts ranging iteratively of from about 800 ppm to about 2000 ppm, alternatively from about 800 ppm to about 1500 ppm, alternatively from about 1500 ppm. Alternatively, the nucleator is a norbornane carboxylic acid salt present in amounts ranging iteratively from about 200 ppm to about 1000 ppm, alternatively from about 200 ppm to about 500 ppm, alternatively from about 250 ppm.

In an embodiment, a modifier that may function as both a nucleator and clarifier is a sorbitol compound or derivative of sorbitol, alternatively dibenzylidene sorbitol. The all-organic sorbitol-based modifier may dissolve in the polymeric composition at temperatures of from about 390° F. to about 430° F. Without wishing to be limited by theory, the dissolving action of the sorbitol may contribute to greater clarity by further reducing the size of the crystallites. In an embodiment, a sorbitol modifier is present in the polymeric composition in amounts ranging iteratively of from about 1500 ppm to about 3000 ppm, alternatively from about 1500 ppm to about 2500 ppm, alternatively from about 1800 ppm to about 2000 ppm. Without wishing to be limited by theory, a suitable nucleator is one capable of promoting rapid nucleation following a plastics shaping process such that the newly formed article rapidly develops mechanical strength sufficient to withstand subsequent processing steps without deformation. Examples of suitable modifiers that function as both clarifiers and nucleators include without limitation Millad 3988, a powdered sorbitol available from Milliken Chemical of Spartanburg, S.C. and Irgaclear DM-LO, a sorbitol-based modifier available from Ciba Specialty Chemicals.

In an embodiment, the polymeric composition may contain modifiers as necessary to impart desired physical properties. Examples of modifiers include without limitation stabilizers, ultra-violet screening agents, oxidants, acid neutralization agents, anti-oxidants, anti-static agents, ultraviolet light absorbents, fire retardants, processing oils, mold release agents, coloring agents, pigments/dyes, fillers, and/or the like with other components. The modifiers may be added in amounts effective to suit the particular needs or desires of a user or maker, and various combinations of the additives may be used. For example, stabilizers or stabilization agents may be employed to help protect the polymer resin from degradation due to exposure to excessive temperatures and/or ultraviolet light. The aforementioned modifiers may be used either singularly or in combination to form various formulations of the polymer. These modifiers may be included in amounts effective to impart the desired properties. Effective modifier amounts and processes for inclusion of these additives to polymeric compositions are known to one skilled in the art.

In an embodiment, a modifier may be added to the polymeric composition in the form of a powder or a fluff after the polymerization process but before the polymer is melted and formed into pellets. Techniques for blending polymeric components may be used. Such techniques are known to one skilled in the art. Examples of suitable blending techniques include without limitation solution blending, solid state physical admixture, molten state admixture, extrusion admixture, roll milling, screw extrusion, and the like.

The polymeric composition may be converted to an intermediate article, referred to as a preform, which may be subsequently converted to an end-use article. The conversion of the polymeric material to a preform and subsequently an end-use article may occur on one production line. Alternatively, the polymeric composition may be converted to a preform, stored and or shipped and then later converted to an end-use article. Alternatively, the polymeric composition may be directly converted to an end use article. The sequence and timing of the conversion of a polymeric composition to a preform or end-use article may be designed by one skilled in the art to meet the needs of the user. Polymeric compositions of the type disclosed herein may be converted into an end-use article through a variety of plastic shaping processes. Plastic shaping processes are known to one skilled in the art and include for example injection stretch blow molding (ISBM).

In ISBM, molten polymer is injected into the mold cavity to produce the desired shape of the intermediate or preform article. A mandrel or core pin is in place during the molding that functions to form the inner diameter of the article. The preform is cooled quickly in the mold cavity then removed from the initial mold and reheated or conditioned. The reheated preform is then stretched axially and using air pressure blown to expand the internal volume to its final dimensions.

Examples of end use articles into which the polymeric composition may be formed include tubes, bottles, containers, cups, and so forth. In an embodiment, the end-use article is a packaging container for a consumer product such as, a food storage container, or a beverage container. Additional end use articles would be apparent to those skilled in the art. Conditions and processes for formation of an end-use article are known to one skilled in the art.

The end-use articles of this disclosure may rapidly develop an impact strength and stiffness sufficient to resist deformation when packed and palletized. Alternatively, the end-use articles of this disclosure may rapidly develop an impact strength and stiffness sufficient to resist deformation when filled with a material such as a liquid. In an embodiment, the end-use article achieves a mechanical strength sufficient to resist deformation by subsequent processing in less than about 4 minutes following formation thereof. All mechanical properties were determined in accordance with what is referred to as a modification of the referenced ASTM method. Herein a modified ASTM method refers to determination of the mechanical properties described at multiple time points beginning with 2 hours following a plastics shaping process. The resultant plot of the mechanical properties values may then be extrapolated back to the time of formation of the end-use article or time 0.

The mechanical strength of the end-use articles may be evaluated based on the values of the flexural modulus, tensile modulus and Izod impact strength. Herein references made to the flexural modulus, tensile modulus and Izod impact strength refer to the value of these properties for an article equal to or less than about 4 minutes following a plastics shaping process such as ISBM and are termed the initial mechanical properties of the article. In some embodiments, the values of the initial mechanical properties will be equivalent to the values of these properties at some time greater than about 4 minutes. Without wishing to be limited by theory, end-use articles of this disclosure may display rapid nucleation that results in the rapid development of top load strength following a plastics shaping process as indicated by increases in the above mentioned mechanical properties.

The polymeric composition and end-use articles constructed there from may display improved impact strength as determined by an increase in the Izod impact strength. Izod impact is defined as the kinetic energy needed to initiate a fracture in a specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promotes a brittle rather than ductile fracture. Specifically, the Izod Impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, sample toss energy). In an embodiment, the polymeric composition and end-use articles constructed there from have an initial Izod impact strength of from about 0.7 ft.lb/inch to about 1.5 ft.lb/inch, alternatively from about 0.7 ft.lb/inch to about 1.2 ft.lb/inch as determined in accordance with a modified ASTM D-256A.

The polymeric composition and end-use articles constructed there from may display an improved stiffness as determined by an increase in the flexural modulus. Flexural modulus is an indicator of material stiffness and specifically is a measure of the resistance to breaking or snapping when a material is bent or flexed. The flexural modulus test in broad terms measures the force required to bend a sample material beam. Test specimens prepared from the polymeric compositions are typically 2.5 inch by 0.5 inch by 0.125-inch bars, but other sizes and shapes could be used. A test specimen is typically placed across a span and a load is applied to the center of the specimen. The load is increased until a specified deflection occurs. The length of the span, the load, and the amount of deflection determines the flexural force. In an embodiment, the polymeric composition and end-use articles constructed there from have an initial flexural modulus of from about 100,000 psi to about 160,000 psi as determined in accordance with a modified ASTM D-790.

The polymeric composition and end-use articles constructed there from may also display an improved tensile strength as determined by an increase in the tensile modulus. The tensile modulus test measures the force required to stretch a specimen to the breaking point and the amount the specimen elongates when stretched to that point. Test specimens are often in the shape of bars but other shapes can be used as appropriate for the material being tested. The test procedure is typically performed by an automated apparatus specially designed for performing tensile tests. Two gripping devices within the apparatus are clamped to the specimen at a specified distance from each other. The apparatus moves the gripping devices away from each other so that they pull the specimen apart and stretch it until it breaks. Automated data acquisition modules within the test apparatus measure and record variables such as tensile modulus, tensile strength at yield and at break, stress, strain, elongation at yield, and elongation at break. In an embodiment, the polymeric composition and end-use articles constructed there from have an initial tensile modulus of from about 140,000 psi to about 175,000 psi as determined in accordance with a modified ASTM D-638.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner. Unless otherwise indicated, physical properties were determined in accordance with the test methods previously identified in the detailed description.

### Example 1

The initial flexural modulus of polymeric compositions containing rcPP 7823 MZ, an ethylene-propylene random copolymer available from Total Petrochemicals USA, Inc. as the base resin with different nucleators and/or clarifiers were compared. One formulation containing the rcPP and 2000 ppm of the sorbitol nucleator Millad 3988 was compared to formulations having the nucleator replaced respectively by 500 ppm of Sodium Benzoate, 250 ppm of HPN-68 or 250 ppm of Na-11. A control experiment was carried out with a polymeric composition comprising the rcPP without any nucleator. Table II describes the resin properties of the rcPP 7823 MZ.

TABLE II

| Resin Properties⁽¹⁾ | Typical Value | | ASTM Method |
|---|---|---|---|
| Melt Flow, g/10 min. | 30 | | D-1238 |
| | | | Condition “L” |
| Density, g/cc | 0.900 | | D-1505 |
| Melting Point, ° F. (° C.) | 293 | (145) | DSC⁽²⁾ |

Mechanical Properties⁽¹⁾

| Tensile, psi (MPa) | 4,300 | (30.0) | D-638 |
|---|---|---|---|
| Elongation, % | 11 | | D-638 |
| Tensile modulus, psi (MPa) | 160,000 | (1,100) | D-638 |
| Flexural Modulus, psi (MPa) | 140,000 | (965) | D-790 |
| Notched Izod Impact @ | 1.4 | (74) | D-256A |
| 73° F.-ft.lb./in. (J/m) | | | |
| Unnotched-ft.lb/in (J/m) | No Breaks | (No Breaks) | |
| Drop Impact, 0.125″ plaques, | 155 | (17.5) | API |
| in.-lbs (J) | | | |

| | | |
|---|---|---|
| Hardness Rockwell R | 84 | D-785A |

Thermal Properties⁽¹⁾

| | | |
|---|---|---|
| Heat Deflection | | D-648 |
| ° F. at 66 psi | 190 | |
| ° C. at 4.64 kg/cm² | 88 | |

⁽¹⁾Data developed under laboratory conditions and are not to be used as specification, maxima or minima.
⁽²⁾MP determined with a DSC-2 Differential Scanning Calorimeter.

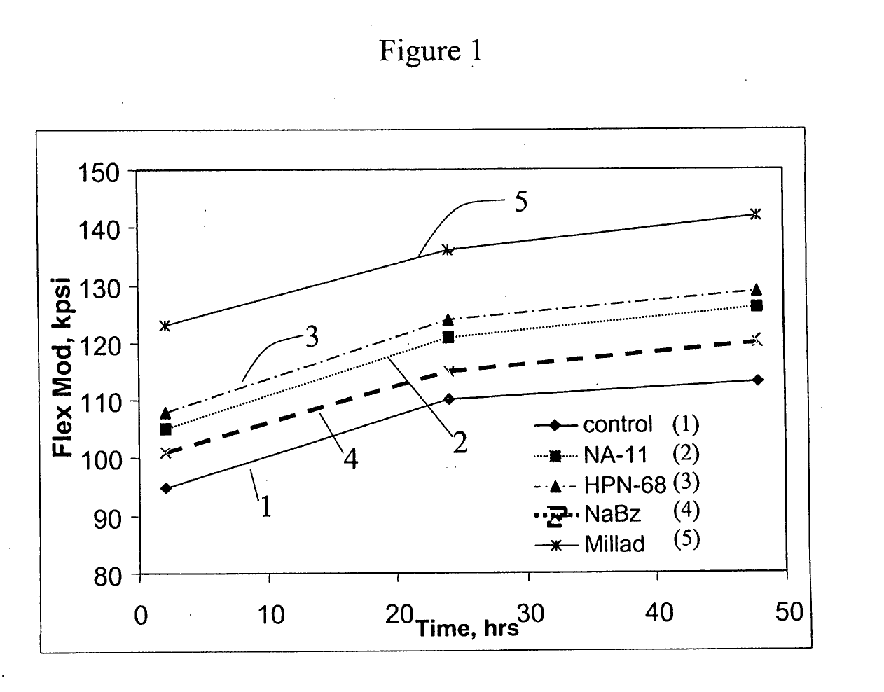

The flexural modulus of the different polymeric compositions was measured as a function of time at 2, 24 and 48 hr in accordance with a modified ASTM D-790, and the results are plotted in FIG. 1. The results show an increase in stiffness with time and an increase of stiffness initially with the different nucleators/clarifiers.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

1-20. (canceled)

21. A method of forming Injection Stretch Blow Molded Articles comprising:
forming a polymeric composition, wherein the polymeric composition comprises polypropylene and from about 200 ppm to about 800 ppm of a nucleating agent comprising a norbornane carboxylic acid salt;
injection stretch blow molding the polymeric composition into an injection stretch blow molded article, wherein the article exhibits an initial flexural modulus of from about 100,000 psi to about 160,000 psi.

22. The method of claim 21, wherein the polypropylene comprises an ethylene-propylene random copolymer.

23. The method of claim 22, wherein an ethylene content of the ethylene-propylene random copolymer is from about 0.1 wt. % to about 5 wt. %.

24. The method of claim 22, wherein the ethylene-propylene random copolymer exhibits a melt flow rate of from about 2 g/10 min. to about 80 g/10 min.

25. The method of claim 22, wherein the ethylene-propylene random copolymer exhibits a melting point of from about 120° C. to about 165° C.

26. The method of claim 21, wherein the article exhibits an Izod impact strength of from about 0.7 ft.lb/inch to about 1.5 ft.lb/inch.

27. The method of claim 21, wherein the article exhibits a tensile modulus of from about 120,000 psi to about 175,000 psi.

28. An Injection Stretch Blow Molded Article formed by claim 21.

29. The article of claim 28, wherein the article is a bottle.
